(19) United States
(12) Patent Application Publication
(10) Pub. No.: US 2026/0212426 A1
(43) Pub. Date: Jul. 23, 2026

(54) TimeCurrency: A Human-Centric Temporal Value Exchange Protocol

(71) Applicant: FURONG BEI, SAN GABRIEL, CA (US)

(72) Inventor: FURONG BEI, SAN GABRIEL, CA (US)

(21) Appl. No.: 19/087,618

(22) Filed: Mar. 24, 2025

Related U.S. Application Data
(63) Continuation-in-part of application No. 19/080,825, filed on Mar. 15, 2025.
(63) Continuation-in-part of application No. 19/083,345, filed on Mar. 18, 2025.
(63) Continuation-in-part of application No. 19/067,907, filed on Mar. 2, 2025.
(63) Continuation-in-part of application No. 19/069,278, filed on Mar. 4, 2025.
(63) Continuation-in-part of application No. 19/059,110, filed on Feb. 20, 2025, now abandoned.
(63) Continuation-in-part of application No. 19/060,663, filed on Feb. 22, 2025.
(63) Continuation-in-part of application No. 19/070,545, filed on Mar. 5, 2025.
(63) Continuation-in-part of application No. 19/078,276, filed on Mar. 13, 2025.
(63) Continuation-in-part of application No. 19/067,845, filed on Mar. 1, 2025.
(63) Continuation-in-part of application No. 19/072,412, filed on Mar. 6, 2025.
(63) Continuation-in-part of application No. 19/070,548, filed on Mar. 5, 2025.
(63) Continuation-in-part of application No. 19/072,953, filed on Mar. 6, 2025.
(63) Continuation-in-part of application No. 19/079,378, filed on Mar. 13, 2025.
(63) Continuation-in-part of application No. 19/069,205, filed on Mar. 3, 2025.
(63) Continuation-in-part of application No. 19/064,689, filed on Feb. 27, 2025.
(63) Continuation-in-part of application No. 19/076,910, filed on Mar. 11, 2025.
(63) Continuation-in-part of application No. 19/083,396, filed on Mar. 18, 2025.
(63) Continuation-in-part of application No. 19/067,732, filed on Feb. 28, 2025.
(63) Continuation-in-part of application No. 19/084,806, filed on Mar. 20, 2025.
(63) Continuation-in-part of application No. 19/087,483, filed on Mar. 22, 2025.
(63) Continuation-in-part of application No. 19/084,779, filed on Mar. 20, 2025.
(63) Continuation-in-part of application No. 19/087,637, filed on Mar. 24, 2025.
(63) Continuation-in-part of application No. 19/067,932, filed on Mar. 2, 2025, now abandoned.
(63) Continuation-in-part of application No. 19/072,075, filed on Mar. 6, 2025.
(63) Continuation-in-part of application No. 19/083,357, filed on Mar. 18, 2025.
(63) Continuation-in-part of application No. 19/085,925, filed on Mar. 20, 2025, now abandoned.
(63) Continuation-in-part of application No. 19/056,745, filed on Feb. 19, 2025.
(63) Continuation-in-part of application No. 19/083,371, filed on Mar. 18, 2025.
(63) Continuation-in-part of application No. 19/086,150, filed on Mar. 21, 2025.
(63) Continuation-in-part of application No. 19/074,326, filed on Mar. 8, 2025, now abandoned.
(63) Continuation-in-part of application No. 19/074,352, filed on Mar. 8, 2025.
(60) Provisional application No. 63/759,784, filed on Feb. 18, 2025.
(60) Provisional application No. 63/769,143, filed on Mar. 9, 2025.
(60) Provisional application No. 63/770,351, filed on Mar. 12, 2025.
(60) Provisional application No. 63/770,359, filed on Mar. 12, 2025.
(60) Provisional application No. 63/770,355, filed on Mar. 12, 2025.
(60) Provisional application No. 63/772,633, filed on Mar. 16, 2025.
(60) Provisional application No. 63/772,637, filed on Mar. 16, 2025.

(51) Int. Cl. G06Q 40/12

(52) U.S. Cl. CPC G06Q 40/125

(57) ABSTRACT

A computer-implemented architecture generates and settles time-denominated value units from verified behavioral time events. A subject identity anchor is authenticated, a digitally signed behavioral event record from an authorized source is received, and a Time-Proof binds the event or an evidence commitment to a time reference and a validity window with replay-prevention material. A signed, versioned policy bundle governs issuance rules, weighting coefficients, routing rules, privacy constraints, and audit permissions. Upon successful verification, a minting engine executes a single atomic state transition that mints one or more time-denominated value units, binds them to the identity anchor, and generates a mint certificate. A namespace resolver maps a human-readable namespace identifier to signed endpoint records for minting, policy, audit, exchange, clearinghouse, or settlement functions. Decision receipts, settlement receipts, exchange-rate inputs, and auditable reports support clearing, conversion, reconciliation, privacy-preserving compliance verification, and bounded rollback.

### CROSS-REFERENCE TO RELATED APPLICATIONS

This application is related to and may claim priority to one or more earlier filings by the Applicant. Any such relationship, where applicable, is identified in an Application Data Sheet (ADS) or in Applicant submissions in the Patent Center record. Certain related filings may, by way of non-limiting example, describe product and service layers including TimeToken issuance, TimeBank account or vault abstractions, TimeGate exchange interfaces, reputation-linked valuation, and dynamic valuation controls; any such references are informational except to the extent expressly set forth in the ADS.

### STATEMENT REGARDING FEDERALLY SPONSORED RESEARCH OR DEVELOPMENT

Not applicable.

### INCORPORATION BY REFERENCE

Any document identified in the application record may be incorporated by reference only to the extent permitted by law and USPTO practice. No subject matter is incorporated by reference in a manner that introduces new matter into this disclosure.

### TECHNICAL FIELD

The present disclosure relates to distributed computing, cryptographically verifiable event proofs, decentralized identity anchoring, policy-controlled issuance of digital value units, and interoperable conversion and clearing across heterogeneous ledgers.

### BACKGROUND

Time-based credit systems and time banking attempt to recognize and exchange human contributions measured in time. However, conventional implementations often rely on centralized bookkeeping, manual attestations, and ad hoc reconciliation among organizations.

In distributed and cross-domain environments, technical challenges include unverifiable event claims and duplicate counting, fragmented identity and addressing, high reconciliation overhead, limited auditability, and weak dispute and revocation handling.

When different contribution categories are valued or exchanged differently (e.g., production oriented vs. care-oriented time), additional stability challenges arise, including category imbalance and volatile conversion spreads. Conventional systems typically do not include a technical control loop to maintain stability across categories while preserving auditability and interoperability.

Generic tokenization of “time” on a general-purpose ledger may not provide a verifiable linkage between a claimed time event and a cryptographically bound identity anchor, and may not provide deterministic policy execution, receipt schemas, or atomic settlement semantics necessary for reliable cross-domain settlement.

### SUMMARY

Namespace-anchored identity: resolvable namespace identifiers bound to endpoints and public key credentials.
Time-Proof objects: canonicalization+cryptographic commitment+verifiable token+anti replay elements.
Deterministic policy container: machine-readable issuance rules+risk controls+decision receipts (rule ID, reason code, policy version).
Stability-control feedback loop: computes trust score, contribution index, and volatility metric; adjusts caps/weights/spreads; logs adjustments.
Interoperability gateway: conversion/clearing API with atomic settlement, exchange-rate snapshots, oracle provenance identifiers, and finality indicators.
Lifecycle controls: disputes, revocation, bounded clawback, inheritance rules, privacy preserving presentations, and analytics reporting.
Product-service layer: time-denominated units may be represented as TimeTokens and managed using TimeBank, Time Vault, and TimeGate interfaces for storage, transfer, conversion, inheritance, and controlled presentation without limiting the underlying ledger architecture.
Dynamic valuation and reputation signals: policy-controlled weighting may incorporate reputation-linked and context-sensitive factors for exchange, prioritization, or bounded adjustment while preserving the canonical underlying time-event record and receipt chain.

### BRIEF DESCRIPTION OF THE DRAWINGS

FIG. 1 illustrates an example system architecture including client devices, verifier nodes, minting nodes, ledger infrastructure, oracle services, clearing gateways, and index/analytics nodes.

FIG. 2 illustrates example identity anchor resolution using a namespace identifier mapped to an endpoint and public-key credential, including key rotation and revocation lists.

FIG. 3 illustrates an example time-event record schema and pre-processing including canonicalization, schema validation, and duplicate checks.

FIG. 4 illustrates example Time-Proof generation and verification including commitment building, signature generation, and verification procedures.

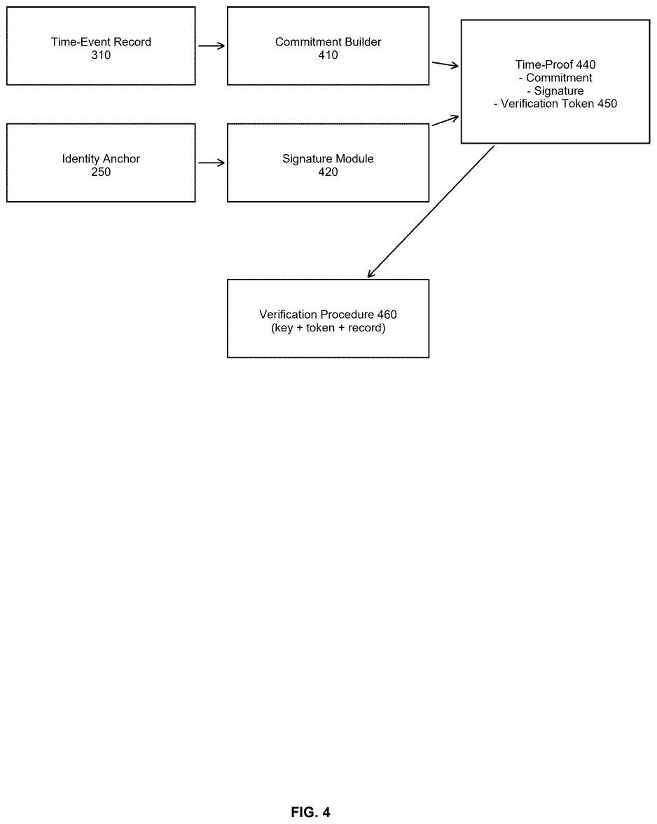

FIG. 5 illustrates example deterministic policy container evaluation using issuance rules and risk signals to produce approve/deny decisions and auditable decision receipts.

FIG. 6 illustrates example mint transactions and mint receipts, and independent verification of receipts and Time-Proofs.

FIG. 7 illustrates example conversion and atomic settlement across heterogeneous ledgers, including exchange-rate snapshots and finality receipts.

FIG. 8 illustrates an example risk scoring pipeline including anomaly detection, duplicate detection, and issuance velocity checks.

FIG. 9 illustrates an example privacy-preserving presentation used to prove rule satisfaction without revealing sensitive attributes.

FIG. 10 illustrates an example index and analytics subsystem and report export interfaces.

FIG. 11 illustrates an example inheritance rule engine and beneficiary transfer transactions.

FIG. 12 illustrates an example dispute, revocation, and bounded clawback workflow and corresponding receipts.

### DETAILED DESCRIPTION

The following description is provided to enable a person of ordinary skill in the art to make and use the disclosed embodiments. The implementations described are illustrative and not limiting. Variations, substitutions, and equivalents are contemplated within the scope of the claims.

### 1. Definitions

Identity Anchor. A binding between a resolvable namespace identifier and a public-key credential that enables verification of commitments and signatures for an account.
Resolvable Namespace Identifier. An identifier that can be resolved to an endpoint, such as a domain/subdomain route, namespace path, or other resolvable naming construct.
Time-Event Record. A structured record including at least: activity identifier, time quantity, context descriptor, and an anti-replay element (nonce, sequence, and/or timestamp).
Canonical Representation. A deterministic canonical form of a time-event record produced by applying normalization rules.
Time-Proof. A cryptographic object comprising (i) a commitment to a canonical representation bound to an identity anchor and (ii) a verifiable token verifiable using a public-key credential.
Policy Container. A deterministic rule-execution component applying machine-readable issuance rules and risk controls, producing an auditable decision receipt.
Decision Receipt. A receipt including at least a rule identifier, a reason code, and a policy version identifier for audit and reconciliation.
Settlement Receipt. A receipt including an exchange-rate snapshot, oracle provenance identifier, and finality indicator for a conversion/clearing operation.
Finality Indicator. A settlement state selected from a defined set: committed, rolled_back, or pending_confirmation.
Oracle Provenance Identifier. A field identifying a source and provenance of an exchange-rate snapshot (provider ID, signature proof, normalization metadata).
Trust Score. A computed metric derived from verification history, dispute outcomes, and measurable integrity signals.
Contribution Index. A computed metric derived from verified categories and outcomes, used for stability control and issuance governance.
Volatility Metric. A computed measure representing imbalance between categories or ledgers, such as net flow difference, balance divergence, or conversion slippage.
Revocation List. A list identifying compromised keys, invalidated proofs, disqualified verifiers, or revoked evidence tokens.
Behavioral Economics Identity (BEI). A human-centric identity framework in which accounts are bound to identity anchors and in which verified behavioral and time-event records are used as inputs to policy-controlled issuance and settlement of time-value units.
Time Currency (TimeCurrency). A class of time-value units denominated in time quanta and minted based on verified time-event records, optionally associated with a production-oriented category.
BR Currency. In some embodiments, an additional class of behavior-referenced value units derived from verified behavioral contribution indicators and governed by machine-readable issuance rules in the policy container; BR Currency may be implemented as a distinct category or tag within the ledger infrastructure.
BEIMINT. A non-limiting system name for a minting node namespace and service that executes the policy container, generates Time-Proofs and decision receipts, and writes mint transactions to the ledger infrastructure.
BEI INDEX. A non-limiting system name for an index and analytics subsystem that computes time-index metrics, exports audit reports, and provides dashboards over ledger events and receipts.
BEI GX. A non-limiting system name for an exchange/clearing gateway that provides cross domain interoperability, conversion and clearing APIs, atomic settlement with finality indicators, and settlement receipts with oracle provenance identifiers.
BEICX. A non-limiting system name for a BEI clearing connector (CX) gateway that interfaces with external ledgers/rails and produces settlement receipts with oracle provenance identifiers and finality indicators.
BEISX. A non-limiting system name for a BEI settlement/exchange (SX) gateway that performs conversion and clearing operations and records auditable settlement receipts.
BEIMX. A non-limiting system name for a BEI market/exchange (MX) gateway that provides interoperability adapters, routing, and settlement services using the conversion and clearing API.
BEIINDEX. A non-limiting system name for a BEI index and analytics node that computes index metrics and produces signed audit-grade export reports.
BEI Currency (BEICurrency). A non-limiting system name for a conversion and clearing portal that exposes the conversion API and returns settlement receipts with finality and provenance fields.
MF.app/Money Factory (MF). A non-limiting system name for a mint-factory deployment that executes policy-controlled minting, receipt generation, and lifecycle controls for time-value or behavior-referenced units.
BEI.app. A non-limiting system name for a primary portal that routes user sessions to identity anchor resolution, time-event submission, minting, conversion/clearing, and reporting endpoints using namespace routing.
BEIECO.com. A non-limiting system name for an ecosystem governance and policy administration portal that manages policy container versions, rule catalogs, revocation lists, and audit exports.
24HWS.com. A non-limiting system name for a multi-hive deployment that partitions services (identity, minting, clearing, analytics) into scalable service hives with versioned interfaces and receipts.
BEITOKEN.com. A non-limiting system name for token issuance and registry services that manage token metadata, category tags, and compatibility badges, and that interface with the policy container and ledger infrastructure.
BEIEID.com. A non-limiting system name for an enterprise identity namespace used to issue and verify organization-scoped credentials and verifier attestations bound to identity anchors.
TimeToken. A time-denominated value unit minted from a verified time-event record and represented in a transferable ledger-compatible form suitable for storage, presentation, exchange, inheritance, or controlled conversion.
TimeBank. A non-limiting account, wallet, or vault abstraction that stores TimeTokens and associated receipts, policy states, beneficiary designations, and exchange permissions.
TimeGate. A non-limiting exchange and interoperability gateway that presents conversion, transfer, and settlement interfaces for TimeTokens, including controlled interaction with external ledgers, accounts, rails, or service systems.
TimeVault. A non-limiting long-horizon storage or beneficiary-transfer construct for preserving TimeTokens, receipts, and associated policy metadata for deferred transfer, inheritance, savings, or bounded remediation workflows.
Dynamic Valuation. A policy-controlled valuation adjustment based on one or more measured factors including category, verified reputation, context, exchange conditions, or risk signals, without changing the canonical underlying time quantity recorded in a Time-Event Record.
Reputation Metric. A computed metric derived from verified history, dispute outcomes, fulfillment quality, or other integrity-related signals, usable as an input to Dynamic Valuation, prioritization, or policy execution.

### 2. Data Structures and Message Schemas

Embodiments use structured message schemas to improve determinism, verification, and auditability. The following schemas are illustrative and non-limiting.

### TimeEventRecord Schema (Example):

{
“event_id”: “string”,
“account_id”: “string”,
“activity_type”: “string”,
“time_quantity”: {
“value”: “number”,
“unit”: “seconds|minutes|hours”
},
“context”: {
“domain”: “string”,
“category”: “string”,
“endpoint_hint”: “string(optional)”
},
“anti_replay”: {
“nonce”: “string”,
“sequence”: “integer”,
“timestamp”: “RFC3339”
},
“attestations”: [
{
“verifier_id”: “string”,
“signature”: “base64”,
“issued_at”: “RFC3339”
}
],
“device”: {
“device_id”: “string(optional)”,
“fingerprint”: “string(optional)”
},
“metadata”: {
“tags”: [
“string”
],
“policy_hint”: “string(optional)”
}
}
TimeProof Schema (example):
{
“anchor_id”: “string”,
“commitment”: “hex”,
“verifiable_token”: “base64(signature or proof)”,
“anti_replay_nonce:”“string”,
“context_hash”: “hex(optional)”,
“created_at”: “RFC3339”
}
DecisionReceipt (example):
{
“tx_hash”: “hex”,
“policy_version”: “string”,
“rule_id”: “string”,
“reason_code”: “string”,
“risk_score”: “number(optional)”,
“time_proof_ref”: “hex”,
“timestamp”: “RFC3339”
}
SettlementReceipt (example):
{
“settlement_id”: “string”,
“finality”: “committed|rolled_back|pending_
confirmation”, “rate_snapshot”: {
“pair”: “string”,
“price”: “number”,
“timestamp”: “RFC3339”
},
“oracle_provenance_id”: “string”,
“counterparty”: “string”,
“timestamp”: “RFC3339”
}

### 3. Architecture and Components

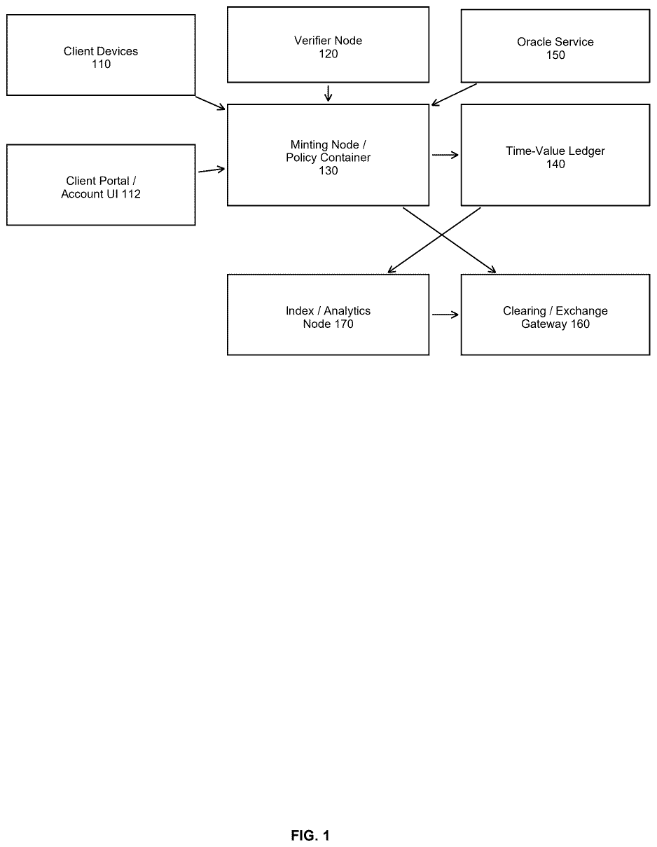

FIG. 1 depicts an example architecture. Client devices submit time-event records through a client portal. Verifier nodes issue attestations for performed activities. A minting node evaluates issuance rules within a policy container, generates or verifies Time-Proofs, and writes mint transactions to a ledger infrastructure.

The ledger infrastructure may be implemented as a distributed ledger, a partitioned ledger, or a hybrid ledger with on-chain hashes and off-chain encrypted records. A clearing gateway provides conversion and atomic settlement services with explicit finality semantics. Oracle services provide exchange-rate snapshots or other external inputs. Oracle provenance identifiers record the source and authenticity of oracle data. Index/analytics nodes compute metrics and export audit reports.

### 3.1 Namespace Resolution and Identity Anchors

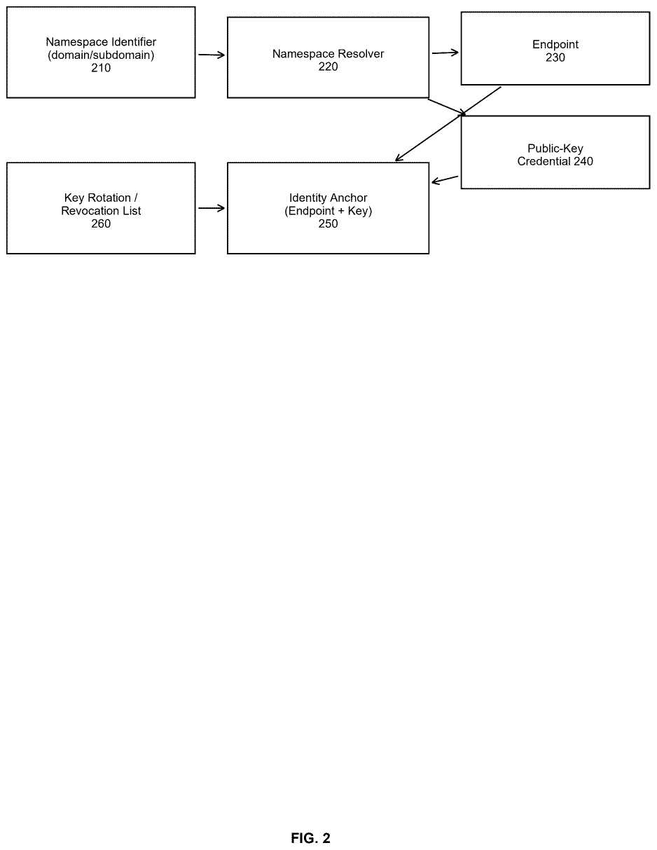

Namespace identifiers may be domain/subdomain routes or other resolvable namespace paths. Resolvers map identifiers to endpoints and public-key credentials (FIG. 2).
Identity anchors support key rotation and revocation checks. Rotation events and revocation list updates are logged and may be auditable.
Resolver results may be cached with expiration; integrity proofs may be used to prevent tampering.

### 4. Time-Proof Pipeline

### 4.1 Canonicalization

Canonicalization applies deterministic normalization rules to a time-event record. Example rules include: normalized field ordering, normalized unit conversion, canonical encoding (e.g., UTF-8), and removal of non-deterministic whitespace.
canonical_bytes=Canonicalize(TimeEventRecord)
context_hash=Hash(context_descriptor)
commitment=Hash(canonical_bytes | anchor_id | anti_replay_nonce | context_hash)
token=Sign(commitment, private_key)
TimeProof={anchor_id, commitment, token, anti_replay_nonce, context_hash}

### 4.2 Verification

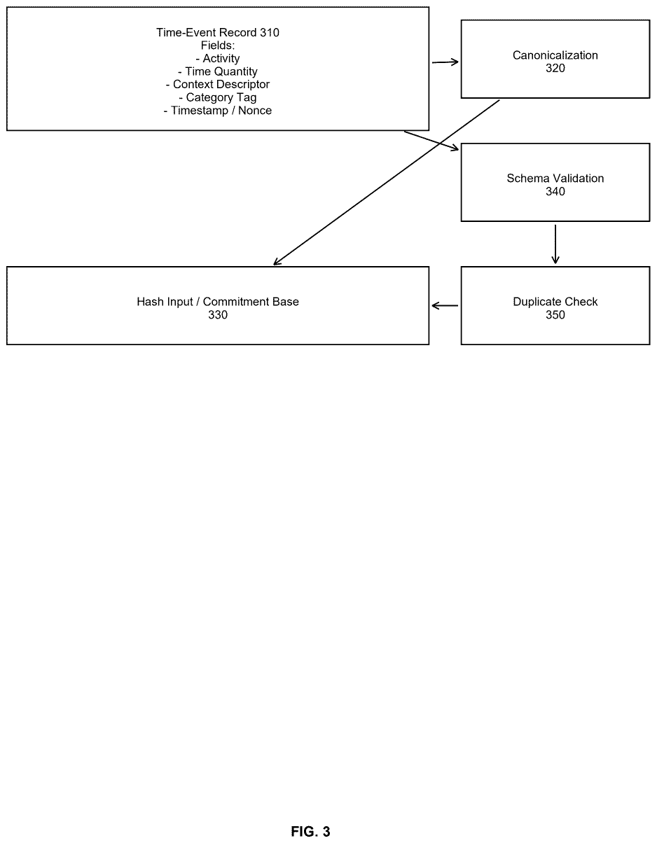

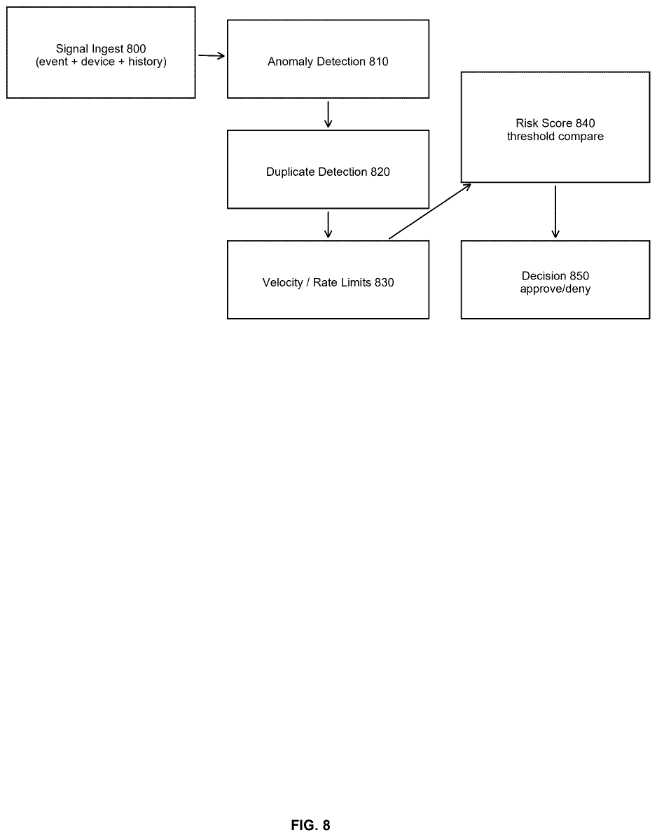

1. Resolve namespace identifier→endpoint+public-key credential (FIG. 2). 2. Recompute commitment from canonical bytes and anti-replay element. 3. Verify signature/proof token using public key.
4. Check revocation lists for compromised keys, invalidated proofs, or disqualified verifiers. 5. Perform freshness checks (nonce uniqueness, sequence monotonicity, timestamp bounds). 6. Perform duplicate-event detection and inconsistency checks (FIG. 3, FIG. 8).

### 5. Policy Container and Risk Controls

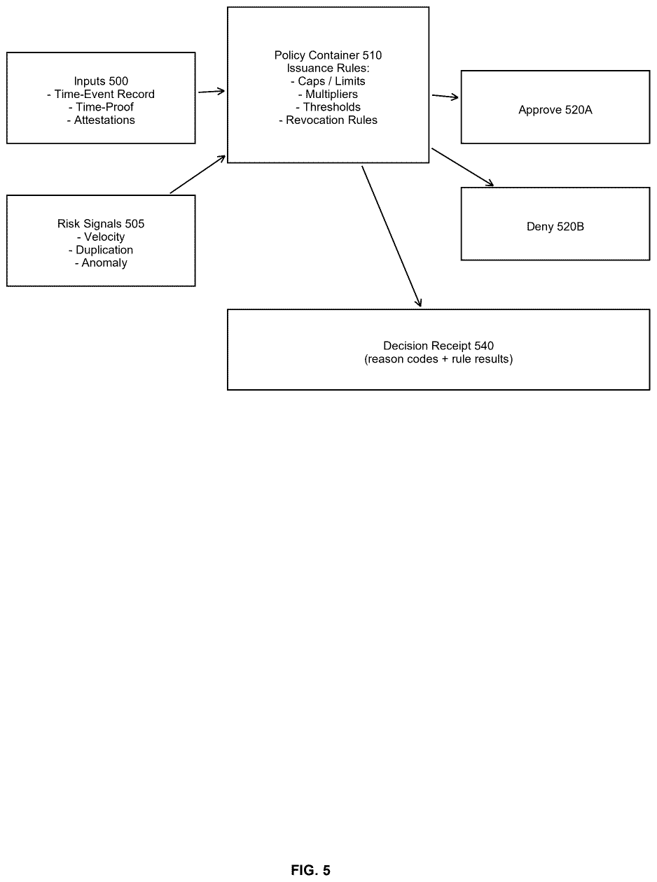

The policy container deterministically executes machine-readable issuance rules and risk controls (FIG. 5). Deterministic execution reduces reconciliation overhead and improves auditability.

### 5.1 Rule Representation (Illustrative)

{
“policy_version”: “v4.0”,
“rule_id”: “RULE_ID”,
“applies_to”: {
“category”: “production|care”,
“domain:”“*”,
“activity_type”: “*”
},
“conditions”: [
{
“type”: “min_attestations”,
“value”: 1
},
{
“type:”“max_units_per_window”,
“value”: 8,
“window”: “day”
},
{
“type”: “freshness_window_minutes”,
“value”: 60
}
],
“risk_controls”: {
“max_risk_score”: 0.7
},
“actions”: [
{
“type:”“mint”,
“multiplier”: 1.0
},
{
“type”: “emit_reason_code”,
“value”: ″“PPROVED_EXAMPLE”
}
]
}

### 5.2 Risk Scoring (FIG. 8)

Risk scoring may incorporate duplicate-event detection, anomaly detection, issuance velocity checks, and device-fingerprint consistency checks.
Duplicate-event detection may compare commitments, event_id, and anti-replay elements across a sliding window.
Velocity checks may enforce caps per account, per verifier, per category, and per endpoint. —Anomaly detection may detect outliers in time quantities, patterns, or device signals. —Device fingerprint checks may detect improbable device/account reuse or automation. risk_score=w1*dup_score+w2*anomaly_score+w3*velocity_score+w4*fingerprint_score if risk_score>threshold: DENY with reason_code=‘DENIED_RISK’ else: proceed to issuance evaluation

### 5.3 Decision Receipts

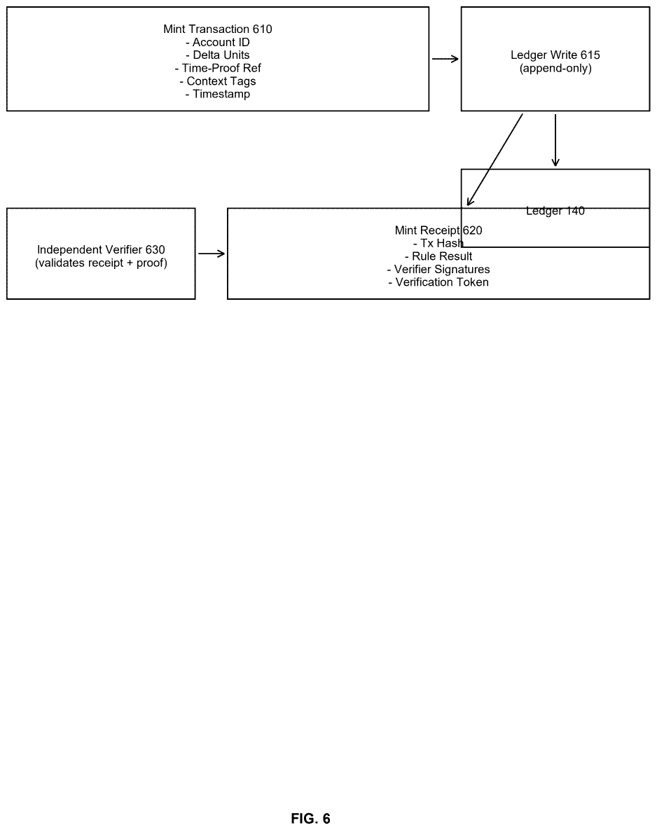

Decision receipts include rule identifiers, reason codes, and policy versions. Receipts may include risk scores and verifier IDs. Receipts are stored with mint transactions (FIG. 6).

### 6. Minting and Ledger Updates

Upon approval, mint transactions update balances and store references to Time-Proofs. Mint receipts enable independent verification (FIG. 6).
MintTransaction={account_id, delta_units, category, time_proof_ref, policy_version, rule_id, timestamp}
LedgerAppend(MintTransaction)
MintReceipt={tx_hash, policy_version, rule_id, reason_code, time_proof_ref, timestamp}

### 7. Stability-Control Feedback Loop

The stability-control module computes trust score, contribution index, and a volatility metric representing imbalance between categories. The module adjusts issuance caps, category weightings, and/or conversion parameters responsive to measured volatility.

### 7.1 Metrics

Trust score may increase with verified attestations and successful audits, and decrease with disputes or revocations.
Contribution index may reflect verified category tags and redemption history, optionally weighted by category norms.
Volatility metric may include net issuance-flow difference, balance divergence, and conversion slippage.
volatility=f(flow_diff(window), balance_divergence( )
conversion_slippage(window))
if volatility>V_HIGH: tighten issuance caps or widen conversion spread elif volatility<V_LOW: relax caps or narrow spread
log {timestamp, volatility, parameter_delta, policy_version}

### 8. Conversion, Clearing, Atomic Settlement, and Finality

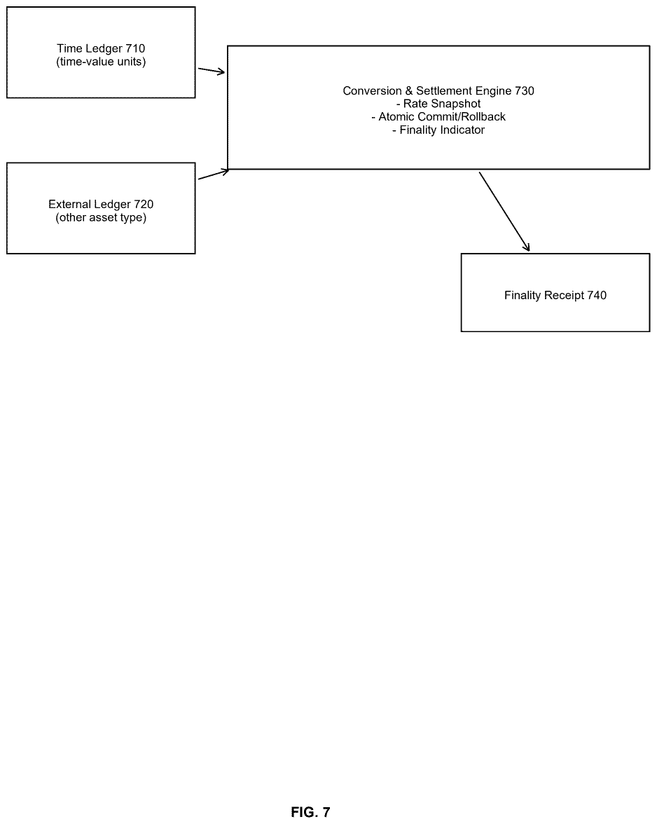

The interoperability gateway provides a conversion and clearing API that performs atomic settlement across ledgers (FIG. 7). Atomic settlement reduces reconciliation overhead by ensuring coupled updates commit or roll back together.

### 8.1 Finality State Machine

States={PENDING_CONFIRMATION, COMMITTED, ROLLED_BACK}
Begin: state=PENDING_CONFIRMATION
Try: apply debit on time-ledger and credit on external-ledger If success: state=COMMITTED
Else: rollback debit/credit; state=ROLLED_BACK
Record SettlementReceipt (finality=state, rate_snapshot, oracle_provenance_id)

### 8.2 Oracle Provenance

Oracle provenance identifiers may include provider identity, timestamp, and signature/proof. Normalization rules for rates may be recorded to support audit.
rate_source_id (provider identifier)
signature or proof-of-origin for rate snapshot
timestamp and normalization metadata
binding of provenance fields to settlement receipt hash

### 9. Privacy-Preserving Presentations

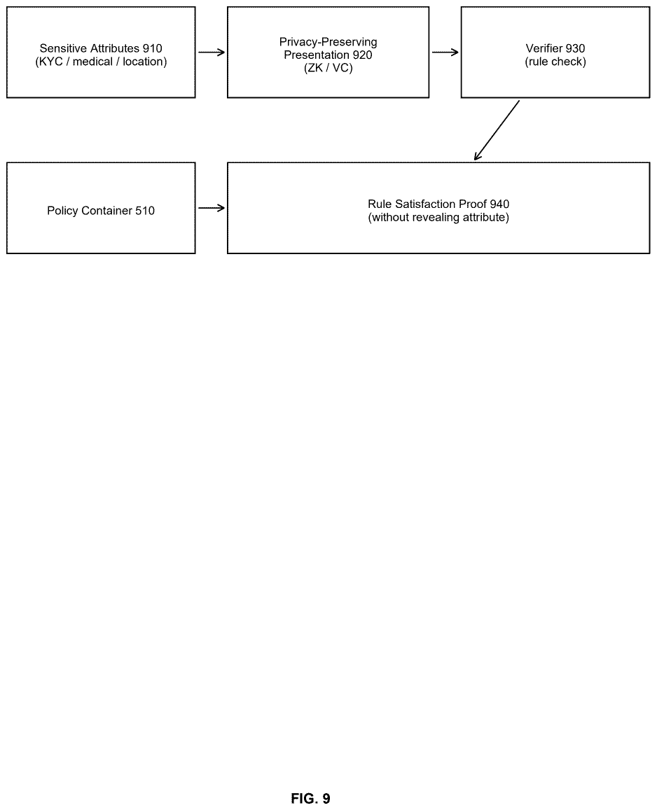

Embodiments may use privacy-preserving presentations (FIG. 9) such as verifiable credentials and/or zero-knowledge proofs to prove rule satisfaction without revealing sensitive attributes.
Selective disclosure attributes (e.g., eligibility) while hiding sensitive medical details. —Binding proofs to identity anchors to prevent reuse across accounts.
Recording only non-sensitive proof metadata in receipts.

### 10. Evidence Tokenization

A Time-Proof or receipt reference may be tokenized as a non-fungible evidence token. Evidence token transfers may be restricted by policy container rules and revocation checks.
EvidenceToken={token_id, tx_hash_ref, time_proof_ref, policy_version,
transferable=true|false}
Transfer subject to PolicyContainer and revocation checks

### 11. Index, Analytics, and Reporting

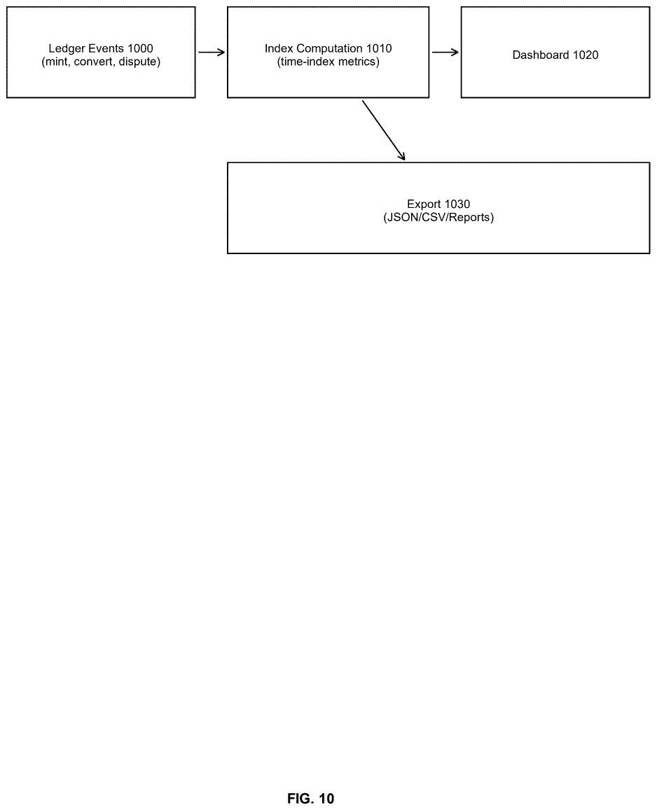

Index/analytics nodes compute metrics and export signed reports (FIG. 10). —Issuance totals and redemptions per category and window
Dispute-adjusted scoring and revocation rates
Finality latency and reconciliation metrics
Machine-readable exports (JSON/CSV) with integrity hashes

### 12. Inheritance Rules

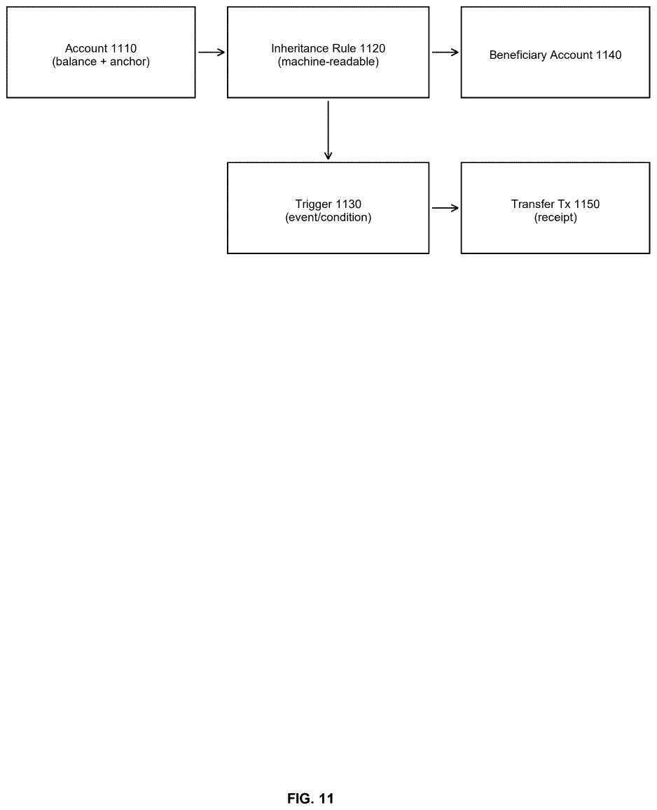

Inheritance rules define beneficiary transfers upon triggering conditions (FIG. 11). —Triggers may be verified events or authorized claims
Transfers recorded with auditable receipts
Optional multi-signature or verifier approvals

### 13. Dispute, Revocation, and Bounded Clawback

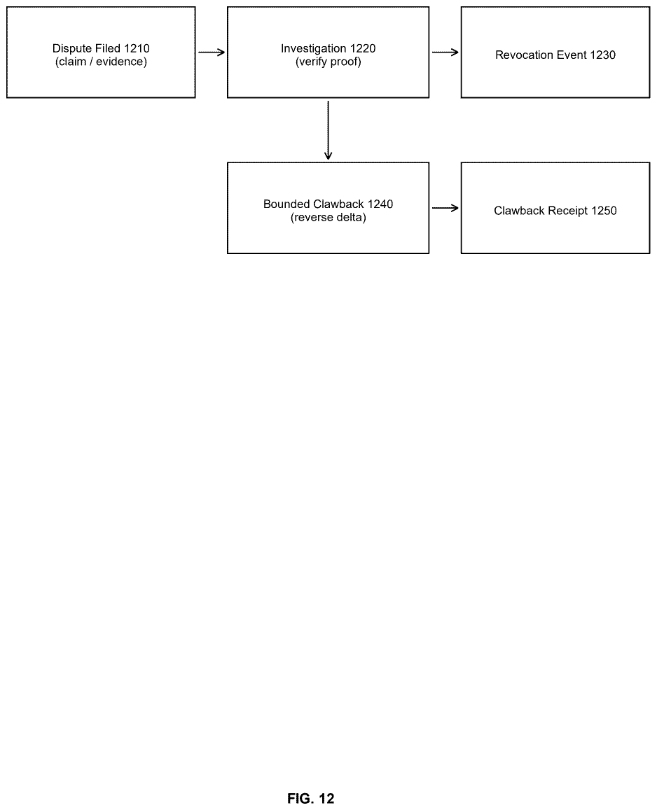

Disputes may be filed with evidence; investigations verify proofs; revocation events may trigger bounded clawback (FIG. 12).
Bounded reversal limited by time window, percentage cap, or category rules-Revocation lists maintained for keys, verifiers, or proofs
Clawback receipts preserve audit trail

### 14. Example Use Cases (Illustrative)

### Work/Service Fulfillment.

7. Verifier signs attestation
8. Policy container checks caps and risk
9. Mint production-category units
10. Issue auditable decision receipt
Caregiving Contributions.
11. Record caregiving event with category tags 12. Stability-control adjusts weighting if imbalance grows 13. Mint care-category units
14. Dispute workflow available
Education Credits.
15. Category endpoint selects education policy 16. Attestations from educators
17. Index metrics for education history
Healthcare Context.
18. Privacy-preserving proof of eligibility
19. Attestation by medical provider
20. Receipts record non-sensitive metadata only
Community Time Credits.
21. Community verifier node
22. Velocity limits to prevent fraud
23. Public audit dashboards
Cross-Ledger Redemption.
24. Obtain oracle rate with provenance
25. Atomic settlement commit/rollback
26. Finality indicator recorded

### APPENDIX A: POLICY CATALOG, RULE FAMILIES, AND DETERMINISTIC DECISION SEMANTICS (ILLUSTRATIVE)

This appendix restates representative issuance policies in a compact, examiner-readable form. The policies remain non-limiting and are intended to illustrate deterministic decision semantics, auditability, and policy-bounded issuance without tying the disclosure to a single code format.

### A1. Common Policy Fields

Representative policy bundles include a policy_version, rule_id, effective_time_window, authorized_source requirements, eligible categories, minting caps, rate limits, replay-prevention constraints, jurisdiction-routing instructions, receipt fields, and denial or downgrade conditions.

### A2. Common Decision Outputs

A policy evaluation may return an allow, allow_with_limit, deny, hold_for_review, freeze, or rollback-eligible outcome. Each outcome is associated with a reason_code, policy_version, rule_id, freshness state, cap state, and reproducible verification path so that the same inputs yield the same decision result across nodes.

### A3. Representative Care-Oriented Rules

CARE_RULE_01. Care-category baseline issuance. Inputs include a care-class behavior record, an authorized attestation source, a valid time-proof, and a category-specific weighting profile. The rule mints baseline time-denominated credit only if the proof falls inside the validity window, the commitment has not already been consumed, issuer status is active, and cumulative exposure remains below policy caps. Decision receipts record the care category, weighting result, cap state, and denial reason when issuance is reduced or denied.

CARE_RULE_02. Care-category baseline issuance. Inputs include a care-class behavior record, an authorized attestation source, a valid time-proof, and a category-specific weighting profile. The rule mints baseline time-denominated credit only if the proof falls inside the validity window, the commitment has not already been consumed, issuer status is active, and cumulative exposure remains below policy caps. Decision receipts record the care category, weighting result, cap state, and denial reason when issuance is reduced or denied.

CARE_RULE_03. Care-category baseline issuance. Inputs include a care-class behavior record, an authorized attestation source, a valid time-proof, and a category-specific weighting profile. The rule mints baseline time-denominated credit only if the proof falls inside the validity window, the commitment has not already been consumed, issuer status is active, and cumulative exposure remains below policy caps. Decision receipts record the care category, weighting result, cap state, and denial reason when issuance is reduced or denied.

CARE_RULE_04. Care-category baseline issuance. Inputs include a care-class behavior record, an authorized attestation source, a valid time-proof, and a category-specific weighting profile. The rule mints baseline time-denominated credit only if the proof falls inside the validity window, the commitment has not already been consumed, issuer status is active, and cumulative exposure remains below policy caps. Decision receipts record the care category, weighting result, cap state, and denial reason when issuance is reduced or denied.

CARE_RULE_05. Care-category baseline issuance. Inputs include a care-class behavior record, an authorized attestation source, a valid time-proof, and a category-specific weighting profile. The rule mints baseline time-denominated credit only if the proof falls inside the validity window, the commitment has not already been consumed, issuer status is active, and cumulative exposure remains below policy caps. Decision receipts record the care category, weighting result, cap state, and denial reason when issuance is reduced or denied.

CARE_RULE_06. Care-category baseline issuance. Inputs include a care-class behavior record, an authorized attestation source, a valid time-proof, and a category-specific weighting profile. The rule mints baseline time-denominated credit only if the proof falls inside the validity window, the commitment has not already been consumed, issuer status is active, and cumulative exposure remains below policy caps. Decision receipts record the care category, weighting

### A4. Representative Production and Professional Rules

PRODUCTION_RULE_07. Production, work, or professional issuance. Inputs include a profession or contribution taxonomy code, proof of completion or attendance, and jurisdiction-aware eligibility constraints. The rule calculates issueable credit using policy coefficients, anti-replay checks, and per-window output caps. It may downgrade issuance when source confidence is lower than a configured threshold, when corroboration is incomplete, or when a queue review flag is triggered.

PRODUCTION_RULE_08. Production, work, or professional issuance. Inputs include a profession or contribution taxonomy code, proof of completion or attendance, and jurisdiction-aware eligibility constraints. The rule calculates issueable credit using policy coefficients, anti-replay checks, and per-window output caps. It may downgrade issuance when source confidence is lower than a configured threshold, when corroboration is incomplete, or when a queue review flag is triggered.

PRODUCTION_RULE_09. Production, work, or professional issuance. Inputs include a profession or contribution taxonomy code, proof of completion or attendance, and jurisdiction-aware eligibility constraints. The rule calculates issueable credit using policy coefficients, anti-replay checks, and per-window output caps. It may downgrade issuance when source confidence is lower than a configured threshold, when corroboration is incomplete, or when a queue review flag is triggered.

PRODUCTION_RULE_10. Production, work, or professional issuance. Inputs include a profession or contribution taxonomy code, proof of completion or attendance, and jurisdiction-aware eligibility constraints. The rule calculates issueable credit using policy coefficients, anti-replay checks, and per-window output caps. It may downgrade issuance when source confidence is lower than a configured threshold, when corroboration is incomplete, or when a queue review flag is triggered.

PRODUCTION_RULE_11. Production, work, or professional issuance. Inputs include a profession or contribution taxonomy code, proof of completion or attendance, and jurisdiction-aware eligibility constraints. The rule calculates issueable credit using policy coefficients, anti-replay checks, and per-window output caps. It may downgrade issuance when source confidence is lower than a configured threshold, when corroboration is incomplete, or when a queue review flag is triggered.

PRODUCTION_RULE_12. Production, work, or professional issuance. Inputs include a profession or contribution taxonomy code, proof of completion or attendance, and jurisdiction-aware eligibility constraints. The rule calculates issueable credit using policy coefficients, anti-replay checks, and per-window output caps. It may downgrade issuance when source confidence is lower than a configured threshold, when corroboration is incomplete, or when a queue review flag is triggered.

### A5. Representative Education, Skill, and Community Rules

SKILL_RULE_13. Education, training, community, or household contribution issuance. Inputs include learning or community evidence, optional institutional signatures, and an integrity check on the event commitment. The rule supports rate-limited issuance, progressive weighting across tiers, and family or household attribution constraints. Receipts capture whether the unit was individually bound, jointly attributed, or redirected under governance rules.

SKILL_RULE_14. Education, training, community, or household contribution issuance. Inputs include learning or community evidence, optional institutional signatures, and an integrity check on the event commitment. The rule supports rate-limited issuance, progressive weighting across tiers, and family or household attribution constraints. Receipts capture whether the unit was individually bound, jointly attributed, or redirected under governance rules.

SKILL_RULE_15. Education, training, community, or household contribution issuance. Inputs include learning or community evidence, optional institutional signatures, and an integrity check on the event commitment. The rule supports rate-limited issuance, progressive weighting across tiers, and family or household attribution constraints. Receipts capture whether the unit was individually bound, jointly attributed, or redirected under governance rules.

SKILL_RULE_16. Education, training, community, or household contribution issuance. Inputs include learning or community evidence, optional institutional signatures, and an integrity check on the event commitment. The rule supports rate-limited issuance, progressive weighting across tiers, and family or household attribution constraints. Receipts capture whether the unit was individually bound, jointly attributed, or redirected under governance rules.

SKILL_RULE_17. Education, training, community, or household contribution issuance. Inputs include learning or community evidence, optional institutional signatures, and an integrity check on the event commitment. The rule supports rate-limited issuance, progressive weighting across tiers, and family or household attribution constraints. Receipts capture whether the unit was individually bound, jointly attributed, or redirected under governance rules.

SKILL_RULE_18. Education, training, community, or household contribution issuance. Inputs include learning or community evidence, optional institutional signatures, and an integrity check on the event commitment. The rule supports rate-limited issuance, progressive weighting across tiers, and family or household attribution constraints. Receipts capture whether the unit was individually bound, jointly attributed, or redirected under governance rules.

### A6. Representative Conversion and Settlement Rules

SETTLEMENT_RULE_19. Conversion, listing, or clearing eligibility. These rules determine whether a minted unit may be listed, exchanged, netted, settled, or mirrored to another rail. Inputs include listing status, endpoint integrity, rate-snapshot provenance, transfer restrictions, and clearinghouse policy. The rule may allow direct settlement, route the unit to delayed reconciliation, or deny external conversion while preserving internal auditability.

SETTLEMENT_RULE_20. Conversion, listing, or clearing eligibility. These rules determine whether a minted unit may be listed, exchanged, netted, settled, or mirrored to another rail. Inputs include listing status, endpoint integrity, rate-snapshot provenance, transfer restrictions, and clearinghouse policy. The rule may allow direct settlement, route the unit to delayed reconciliation, or deny external conversion while preserving internal auditability.

SETTLEMENT_RULE_21. Conversion, listing, or clearing eligibility. These rules determine whether a minted unit may be listed, exchanged, netted, settled, or mirrored to another rail. Inputs include listing status, endpoint integrity, rate-snapshot provenance, transfer restrictions, and clearinghouse policy. The rule may allow direct settlement, route the unit to delayed reconciliation, or deny external conversion while preserving internal auditability.

SETTLEMENT_RULE_22. Conversion, listing, or clearing eligibility. These rules determine whether a minted unit may be listed, exchanged, netted, settled, or mirrored to another rail. Inputs include listing status, endpoint integrity, rate-snapshot provenance, transfer restrictions, and clearinghouse policy. The rule may allow direct settlement, route the unit to delayed reconciliation, or deny external conversion while preserving internal auditability.

SETTLEMENT_RULE_23. Conversion, listing, or clearing eligibility. These rules determine whether a minted unit may be listed, exchanged, netted, settled, or mirrored to another rail. Inputs include listing status, endpoint integrity, rate-snapshot provenance, transfer restrictions, and clearinghouse policy. The rule may allow direct settlement, route the unit to delayed reconciliation, or deny external conversion while preserving internal auditability.

SETTLEMENT_RULE_24. Conversion, listing, or clearing eligibility. These rules determine whether a minted unit may be listed, exchanged, netted, settled, or mirrored to another rail. Inputs include listing status, endpoint integrity, rate-snapshot provenance, transfer restrictions, and clearinghouse policy. The rule may allow direct settlement, route the unit to delayed reconciliation, or deny external conversion while preserving internal auditability.

### A7. Representative Safety, Exception, and Governance Rules

SAFETY_RULE_25. Fraud, Sybil, anomaly, or governance-triggered controls. These rules evaluate issuer reputation, behavioral density, device consistency, timing anomalies, geographic coherence, and policy override conditions. Outputs may include deny, quarantine, freeze, review, or bounded rollback eligibility. Each rule records a machine-verifiable reason path to support later audit, appeals, and consistent supervisory review.

SAFETY_RULE_26. Fraud, Sybil, anomaly, or governance-triggered controls. These rules evaluate issuer reputation, behavioral density, device consistency, timing anomalies, geographic coherence, and policy override conditions. Outputs may include deny, quarantine, freeze, review, or bounded rollback eligibility. Each rule records a machine-verifiable reason path to support later audit, appeals, and consistent supervisory review.

SAFETY_RULE_27. Fraud, Sybil, anomaly, or governance-triggered controls. These rules evaluate issuer reputation, behavioral density, device consistency, timing anomalies, geographic coherence, and policy override conditions. Outputs may include deny, quarantine, freeze, review, or bounded rollback eligibility. Each rule records a machine-verifiable reason path to support later audit, appeals, and consistent supervisory review.

SAFETY_RULE_28. Fraud, Sybil, anomaly, or governance-triggered controls. These rules evaluate issuer reputation, behavioral density, device consistency, timing anomalies, geographic coherence, and policy override conditions. Outputs may include deny, quarantine, freeze, review, or bounded rollback eligibility. Each rule records a machine-verifiable reason path to support later audit, appeals, and consistent supervisory review.

SAFETY_RULE_29. Fraud, Sybil, anomaly, or governance-triggered controls. These rules evaluate issuer reputation, behavioral density, device consistency, timing anomalies, geographic coherence, and policy override conditions. Outputs may include deny, quarantine, freeze, review, or bounded rollback eligibility. Each rule records a machine-verifiable reason path to support later audit, appeals, and consistent supervisory review.

SAFETY_RULE_30. Fraud, Sybil, anomaly, or governance-triggered controls. These rules evaluate issuer reputation, behavioral density, device consistency, timing anomalies, geographic coherence, and policy override conditions. Outputs may include deny, quarantine, freeze, review, or bounded rollback eligibility. Each rule records a machine-verifiable reason path to support later audit, appeals, and consistent supervisory review.

### A8. Policy Family Invariants

Across the foregoing rule families, the policy engine preserves the following invariants: a single commitment is not consumed more than once for the same eligible mint state; receipts include sufficient metadata to reproduce the decision; every decision is attributable to a policy version and effective time window; and jurisdiction-specific rules are applied without destroying cross-network auditability.

### A9. Governance and Tuning Notes

Implementations may tune coefficients, category maps, caps, thresholds, review queues, and settlement permissions while preserving the same policy semantics. Such tuning does not require departure from the described architecture so long as the policy bundle remains authenticated, versioned, and enforceable at the minting and clearing layers.

### APPENDIX B: AUDIT QUERIES, RECEIPT EXPORTS, AND VERIFICATION REPORTS

This appendix summarizes representative audit interfaces and report outputs that support third-party verification, supervisory inspection, and reconciliation workflows.

### B1. Core Query Operations

QueryReceipt(tx_hash): retrieves a decision or mint receipt and validates the rule identifier, reason code, policy version, time-proof reference, and commitment integrity.
QuerySettlement(settlement_id): retrieves a settlement receipt and validates the finality state, rate or oracle provenance, netting batch membership, and reconciliation status.
QueryPolicy(policy_version): retrieves the signed policy bundle and confirms the effective time window, authorized sources, eligible categories, and cap parameters used by the decision engine.
QueryEndpoint(basepoint): resolves the signed endpoint record for minting, policy, audit, listing, or clearing services and validates signature freshness and revocation status.
ComputeIndex(subject_id, window): computes a reproducible metric export over a specified window and returns a signed report hash for independent verification.

### B2. Representative Receipt-Export Fields

Representative exports may include account or subject identifier, namespace basepoint, rule_id, policy_version, reason_code, event commitment hash, time-proof reference, cap state, freshness state, settlement state, oracle provenance, and an export signature or report hash.

### B3. Verification-Report Structure

A verification report may summarize accepted events, denied events, downgraded events, review-queued events, settlement exceptions, and rollback-eligible events for a selected period. Each row may reference the applicable reason path and the endpoint or policy source used at decision time so that audits can be reproduced without disclosing unnecessary sensitive data.

### B4. Supervisory and Privacy Notes

Implementations may publish selective-audit reports that prove rule satisfaction, settlement status, and receipt integrity while omitting underlying personal data, raw evidence, or local confidential business data. The same report schema can be used across internal audits, regulator exports, and dispute-resolution workflows.

### APPENDIX C: IMPLEMENTATION CONFORMANCE CHECKLIST

This appendix provides a non-limiting conformance checklist for implementations seeking functional consistency with the disclosed architecture.

### C1. Identity and Authorization Checks

Verify that each subject is bound to an identity anchor and that issuer authorization is validated against a signed policy bundle or equivalent authenticated source list.
Verify that endpoint records used for issuer, policy, audit, listing, and clearing services are authenticated and checked for freshness and revocation.

### C2. Time-Proof and Anti-Replay Checks

Verify that each minting or decision flow validates a time-proof, a validity window, and a replay-prevention state element such as a nonce, counter, uniqueness constraint, or freshness state.
Verify that a previously consumed commitment cannot be accepted again for the same mint state.

### C3. Policy Enforcement Checks

Verify that each decision or mint event records the policy version, rule identifier, reason code, and cap or threshold state used at evaluation time.
Verify deterministic behavior when the same inputs are presented to multiple nodes under the same policy version.

### C4. Receipt and Integrity Checks

Verify that mint certificates, decision receipts, and settlement receipts are anchored to tamper-evident structures or equivalent integrity-preserving storage.
Verify that exported reports can be recomputed or independently checked using the recorded hashes, signatures, or commitments.

### C5. Clearing and Interoperability Checks

Verify that listing, matching, netting, settlement, and reconciliation steps preserve identity-anchor references and provenance metadata where required by policy.
Verify that adapters to external rails preserve idempotency, rollback semantics, and rate-snapshot provenance.

### C6. Safety and Supervisory Checks

Verify that anomaly, fraud, Sybil, or sanction controls can deny, hold, quarantine, freeze, or initiate bounded rollback according to enumerated policy conditions.
Verify that supervisory or dispute-resolution workflows can obtain a selective audit trail without breaching unnecessary privacy constraints.

### APPENDIX D: COMPUTING ENVIRONMENT (EXPANDED)

Embodiments may be deployed as cloud services, enterprise nodes, or community nodes. The following considerations are illustrative:
Scalability: sharding/partitioning of ledger infrastructure; caching of resolver results; batching of verification operations.
Security: HSM or secure enclave support; key rotation schedules; revocation propagation; receipt integrity checks.
Reliability: idempotent minting; retry semantics for settlement; rollback logs; monitoring and alerting.
Interoperability: adapters for external ledgers; standardized receipt schemas; versioning of policy rules and interfaces.

### APPENDIX E: EXEMPLARY NAMESPACE ROUTING TABLE AND DOMAIN-BASED DEPLOYMENTS

### E1. Example Mapping (Illustrative):

MF.app: Example mint-factory deployment for policy-controlled minting and receipts (Money Factory).
BEI.app: Example primary portal routing users to identity resolution, minting, clearing, and analytics via namespace routing.
BEIECO.com: Example policy administration and governance portal managing rule catalogs, versions, and audit exports.
24HWS.com: Example multi-hive deployment namespace partitioning services for scalability and reliability.
BEITOKEN.com: Example token registry and compatibility service interfacing with policy container and ledger infrastructure.
BEIEID.com: Example enterprise identity namespace for organization-scoped credentials and verifier attestations.
timecurrency.com: Example public portal for account access and time-event submission UI; may route to category-specific endpoints and APIs.
beicurrency.com: Example conversion/clearing portal exposing conversion APIs and settlement receipts with oracle provenance and finality indicators.
beidid.com/beibid.com: Example identity-anchor namespace for resolver endpoints and public-key credential discovery (identity anchor resolution).
beinft.com: Example evidence-token (non-fungible evidence token) service for optional tokenization of Time-Proofs and receipts.
beimint.com/beiminting.com: Example minting node namespace for policy container execution, issuance evaluation, and mint receipt generation.
beigx.com/beicx.com/beisx.com: Example exchange/clearing gateway namespaces for cross domain settlement and interoperability adapters.
beiindex.com: Example index/analytics namespace for time-index metrics, dashboards, and exportable audit reports.

### E2. Example Subdomain Patterns (Non-Limiting)

In some embodiments, user-specific namespaces are expressed as subdomains, while category endpoints are expressed as paths or subdomains. The following examples are illustrative:
account timecurrency.com: https://timecurrency.com/u/{account_id}
user namespace route: {user_id}.timecurrency.com
category endpoint route: care. {user_id}.timecurrency.com/api/mint or production. {user_id}.timecurrency.com/api/mint
conversion endpoint: api.beicurrency.com/convert with SettlementReceipt returned
resolver endpoint: resolve.beidid.com/{namespace_identifier}->{endpoint, public_key_credential, revocation_info}

### E3. Example API Request/Response Contracts

The following example API contracts are illustrative and support auditability and interoperability.

### MintRequest (Example):

{
“namespace_id”: “user123.timecurrency.com”,
“time_event_record”: {
“event_id”: “evt_0001”,
“activity_type”: “caregiving”,
“time_quantity”: {
“value”: 2,
“unit″”“hours”
},
“context”: {
“domain”: “health”,
“category”: “care”
},
“anti_replay”: {
“nonce”: “n-9f2a”,
“sequence”: 41,
“timestamp”: “2026-02-23T10:01:02Z”},
“attestations”: [
{
“verifier_id:”“verifier_120”, “signature”:
“base64 . . .”, “issued_a”″: “2026-02-23T10:01:05Z”}
]
},
“policy_hint”: “CARE_RULE_01”
}
MintResponse (example):
{
“decision_receipt”: {
“tx_hash”: “hex . . ”″,
“policy_version”: “v4.0”,
“rule_id”: “CARE_RULE_01”,
“reason code”: “APPROVED_CARE_CAP”,
“risk_score”: 0.12,
“timestamp”: “2026-02-23T10:01:06Z”},
“time_proof_ref”: “hex . . .”
}
ConvertRequest (example):
{
“from”: {
“asset”: “time_value_units”,
“category”: “care”,
“amount”: 3.0
},
“to”: {
“asset”: “digital_fiat”,
“currency”: “USD”
},
“rate_pair”: “TC_CARE/USD”,
“counterparty”: “cp_001”,
“oracle_preference”: “oracle_150”,
“idempotency_key”: “idem-123”
}
ConvertResponse (example):
{
“settlement_receipt”: {
“settlement_id”: “set_7781”,
“finality”: “committed”,
“rate_snapshot”: {
“pair”: “TC_CARE/USD”,
“price”: 4.25,
“timestamp”: “2026-02-23T10:02:00Z”
},
“oracle_provenance_id”: “oracle_150_sig_abc”,
“counterparty”: “cp_001”,
“timestamp”: “2026-02-23T10:02:03Z”
}
}

### APPENDIX F: FUNCTIONAL MODULE ORGANIZATION AND DEPLOYMENT VARIANTS

This appendix organizes the disclosed architecture into functional module groups and representative deployment variants without imposing claim limitations.

### F1. Functional Module Groups

Identity and authorization group: identity anchors, issuer verification, endpoint-record validation, and subject binding.
Evidence and proof group: behavior-record intake, commitment generation, time-proof generation or validation, and replay-prevention state management.
Minting and receipt group: policy evaluation, atomic minting, mint certificates, decision receipts, and integrity anchoring.
Routing and governance group: namespace basepoints, endpoint records, policy publication, versioning, and effective-window enforcement.
Clearing and interoperability group: listing eligibility, matching, netting, settlement instructions, adapter mapping, reconciliation, and exception handling.
Safety and audit group: anomaly controls, freeze and rollback decisions, report exports, dispute support, and selective supervisory verification.

### F2. Representative Deployment Variants

Single-operator deployment: identity, minting, routing, and clearing services operate under a common administrative domain with internal audit exports.
Federated regional deployment: regional gateways publish endpoint records while preserving shared policy semantics and standardized receipt formats.
Industry-specific deployment: sector namespaces use the same core protocol but apply specialized policy bundles and category taxonomies.
Multi-tenant platform deployment: multiple organizations publish distinct namespace basepoints, while common minting, clearing, or audit services are shared under authenticated endpoint routing.
Supervisory shadow deployment: a regulator or auditor operates read-only verification endpoints and report-generation nodes without participating in minting or settlement.

### F3. Cross-Module Consistency Points

Implementations should preserve consistent identity-anchor references, policy-version references, endpoint-record integrity, and receipt schemas across all deployment variants. Functional decomposition may vary, but the architecture remains aligned when atomic minting, authenticated routing, and auditable settlement semantics are preserved.

### APPENDIX G: SECURITY AND THREAT MODEL (ILLUSTRATIVE)

This appendix provides non-limiting threat models and mitigations relevant to verification, issuance, and settlement.

### G1. Threats

Replay attacks: reuse of time-event records or proofs across accounts or time windows. —Verifier compromise: issuance of fraudulent attestations by a compromised verifier node. —Oracle manipulation: incorrect rate snapshots or provenance spoofing.
Sybil behavior: creation of multiple identities to bypass caps.
Settlement inconsistency: partial updates across ledgers without atomic rollback. —Receipt forgery: attempts to forge decision receipts or settlement receipts.

### G2. Mitigations

Anti-replay nonce/sequence+freshness windows; commitment binding includes anti-replay element.
Key rotation and revocation lists for identity anchors and verifier nodes; revocation checks enforced in policy container.
Oracle provenance identifiers including signatures/proofs and normalization metadata; multiple oracle sources optional.
Risk controls including velocity limits, device-fingerprint consistency checks, and anomaly detection; optional privacy-preserving proofs for eligibility.
Atomic settlement state machine with explicit finality indicators and rollback receipts; idempotency keys for retry safety.
Receipt verification procedure: independent recomputation of commitment and verification token; signed report exports.

### APPENDIX H: WORKED EXAMPLE MATRIX AND VERIFICATION PATTERNS (ILLUSTRATIVE)

This appendix condenses representative worked examples into scenario-oriented verification patterns. Each example remains non-limiting and supports enablement for issuance, routing, and auditability.

### H1. Care and Household Examples

H1. A care-category event is attested by an authorized source, bound to a valid time window, and evaluated under a care-oriented rule family. The system verifies issuer status, anti-replay state, and policy caps before issuing a time-denominated unit or returning a downgrade or denial reason. The resulting receipt records the rule path, freshness state, and category weighting used for the decision.

H2. A care-category event is attested by an authorized source, bound to a valid time window, and evaluated under a care-oriented rule family. The system verifies issuer status, anti-replay state, and policy caps before issuing a time-denominated unit or returning a downgrade or denial reason. The resulting receipt records the rule path, freshness state, and category weighting used for the decision.

H3. A care-category event is attested by an authorized source, bound to a valid time window, and evaluated under a care-oriented rule family. The system verifies issuer status, anti-replay state, and policy caps before issuing a time-denominated unit or returning a downgrade or denial reason. The resulting receipt records the rule path, freshness state, and category weighting used for the decision.

H4. A care-category event is attested by an authorized source, bound to a valid time window, and evaluated under a care-oriented rule family. The system verifies issuer status, anti-replay state, and policy caps before issuing a time-denominated unit or returning a downgrade or denial reason. The resulting receipt records the rule path, freshness state, and category weighting used for the decision.

H5. A care-category event is attested by an authorized source, bound to a valid time window, and evaluated under a care-oriented rule family. The system verifies issuer status, anti-replay state, and policy caps before issuing a time-denominated unit or returning a downgrade or denial reason. The resulting receipt records the rule path, freshness state, and category weighting used for the decision.

### H2. Professional and Production Examples

H6. A professional or production-oriented event includes a profession or contribution code and one or more corroborating attestations. The system validates source authorization, time-proof freshness, and cumulative issuance caps, then either mints a unit, routes the event to review, or denies issuance while preserving a reproducible reason path.

H7. A professional or production-oriented event includes a profession or contribution code and one or more corroborating attestations. The system validates source authorization, time-proof freshness, and cumulative issuance caps, then either mints a unit, routes the event to review, or denies issuance while preserving a reproducible reason path.

H8. A professional or production-oriented event includes a profession or contribution code and one or more corroborating attestations. The system validates source authorization, time-proof freshness, and cumulative issuance caps, then either mints a unit, routes the event to review, or denies issuance while preserving a reproducible reason path.

H9. A professional or production-oriented event includes a profession or contribution code and one or more corroborating attestations. The system validates source authorization, time-proof freshness, and cumulative issuance caps, then either mints a unit, routes the event to review, or denies issuance while preserving a reproducible reason path.

H10. A professional or production-oriented event includes a profession or contribution code and one or more corroborating attestations. The system validates source authorization, time-proof freshness, and cumulative issuance caps, then either mints a unit, routes the event to review, or denies issuance while preserving a reproducible reason path.

### H3. Education, Learning, and Community Examples

H11. A learning or community event is presented with a commitment to supporting evidence and optional institutional signatures. The policy bundle determines the eligible category, weighting coefficient, and transfer or lock conditions. The output receipt records whether the resulting unit is individually attributed, jointly attributed, or reserved for later reconciliation.

H12. A learning or community event is presented with a commitment to supporting evidence and optional institutional signatures. The policy bundle determines the eligible category, weighting coefficient, and transfer or lock conditions. The output receipt records whether the resulting unit is individually attributed, jointly attributed, or reserved for later reconciliation.

H13. A learning or community event is presented with a commitment to supporting evidence and optional institutional signatures. The policy bundle determines the eligible category, weighting coefficient, and transfer or lock conditions. The output receipt records whether the resulting unit is individually attributed, jointly attributed, or reserved for later reconciliation.

### APPENDIX I: INTEROPERABILITY ADAPTER PROFILES AND EXTERNAL-RAIL MAPPING (ILLUSTRATIVE)

This appendix summarizes representative adapter profiles for connecting the routing, conversion, and clearing layers to external systems.

### I1. Common Adapter Fields

Representative adapter profiles specify an adapter_id, version, supported asset types, required finality states, rate-snapshot normalization rules, oracle provenance requirements, idempotency handling, retry policy, rollback semantics, audit-export fields, and verification endpoints.

### I2. Permissioned-Ledger Adapter Profile

This profile translates internal mint, transfer, and settlement states to a permissioned-ledger environment while preserving commitment hashes, policy-version references, and finality signals.

### I3. Messaging and Banking-Rail Adapter Profile

This profile maps internal settlement instructions to ISO-20022-like or equivalent message structures, preserving beneficiary and payer routing references, settlement status, exception codes, and reconciliation identifiers.

### I4. Exchange-Listing Adapter Profile

This profile supports listing or exchange venues that require status checks on policy permissions, lock conditions, provenance identifiers, and auditable rate snapshots before admission or conversion.

### I5. Supervisory Export Adapter Profile

This profile generates selective-audit exports for regulators, auditors, or courts, providing receipt integrity, reason paths, policy-version references, and bounded rollback status while limiting disclosure of underlying private data.

### I6. Adapter Invariants

Across the foregoing profiles, an implementation preserves idempotent processing, policy-consistent exception handling, stable endpoint resolution, and tamper-evident auditability even when external rails use different transport, storage, or finality models.

### APPENDIX H (CONTINUED): ADDITIONAL WORKED EXAMPLES AND SETTLEMENT SCENARIOS

The following additional scenarios extend the worked example matrix to listing, clearing, exception handling, and supervisory review.

### H4. Exchange, Conversion, and Clearing Examples

H14. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

H15. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

H16. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

H17. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

H18. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

H19. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

H20. A minted unit is submitted for listing, conversion, or clearing. The system resolves listing and clearing endpoints from signed namespace records, validates policy permissions and rate-snapshot provenance, and then performs direct settlement, delayed reconciliation, or controlled denial. Settlement receipts preserve finality state, reconciliation batch identifiers, and exception metadata where applicable.

### H5. Exception, Safety, and Supervisory Examples

H21. An event or settlement flow triggers one or more safety controls such as anomaly thresholds, issuer-reputation concerns, duplicate commitment detection, geographic inconsistency, or sanction-related gating. The system may deny, quarantine, freeze, or mark the unit for bounded rollback according to policy. The audit trail records the reason path, review status, and the specific endpoint and policy version used for the exception decision.

H22. An event or settlement flow triggers one or more safety controls such as anomaly thresholds, issuer-reputation concerns, duplicate commitment detection, geographic inconsistency, or sanction-related gating. The system may deny, quarantine, freeze, or mark the unit for bounded rollback according to policy. The audit trail records the reason path, review status, and the specific endpoint and policy version used for the exception decision.

H23. An event or settlement flow triggers one or more safety controls such as anomaly thresholds, issuer-reputation concerns, duplicate commitment detection, geographic inconsistency, or sanction-related gating. The system may deny, quarantine, freeze, or mark the unit for bounded rollback according to policy. The audit trail records the reason path, review status, and the specific endpoint and policy version used for the exception decision.

H24. An event or settlement flow triggers one or more safety controls such as anomaly thresholds, issuer-reputation concerns, duplicate commitment detection, geographic inconsistency, or sanction-related gating. The system may deny, quarantine, freeze, or mark the unit for bounded rollback according to policy. The audit trail records the reason path, review status, and the specific endpoint and policy version used for the exception decision.

H25. An event or settlement flow triggers one or more safety controls such as anomaly thresholds, issuer-reputation concerns, duplicate commitment detection, geographic inconsistency, or sanction-related gating. The system may deny, quarantine, freeze, or mark the unit for bounded rollback according to policy. The audit trail records the reason path, review status, and the specific endpoint and policy version used for the exception decision.

### H6. Example—Family Observations

Across the foregoing examples, the architecture preserves four repeating features: deterministic policy evaluation, replay-resistant proof handling, authenticated endpoint resolution, and receipt-based auditability. These shared patterns support implementations that vary in deployment surface while maintaining the same core issuance and settlement semantics.

### APPENDIX L: GATEWAY, MARKET, AND INDEX DEPLOYMENT PROFILES (ILLUSTRATIVE, NON-LIMITING)

This appendix summarizes representative deployment profiles for gateway, market, analytics, and index functions that may be layered on the disclosed minting and clearing architecture.

### L1. Identity and Admission Gateway Profile

A gateway profile may authenticate a subject, validate endpoint-record integrity, check issuer or policy eligibility, and route admissible requests to minting, audit, exchange, or clearing services.

### L2. Clearing Gateway Profile

A clearing gateway profile may perform intake normalization, queue placement, netting preparation, settlement instruction generation, and reconciliation exports while preserving policy references and finality state.

### L3. Market and Listing Profile

A market profile may evaluate listing permissions, transfer restrictions, rate snapshots, and policy gates before exposing a unit or instrument to listing, conversion, or secondary routing.

### L4. Vault and Custody Profile

A vault-oriented deployment may bind units to lock conditions, hold periods, custody controls, or release workflows while maintaining receipt integrity and auditability.

### L5. Analytics and Index Profile

An analytics or index deployment may compute category, subject, sector, or time-window metrics from signed receipts and policy-consistent event summaries without mutating the underlying mint history.

### L6. Regional and Sector Partition Profile

Regional or sector profiles may partition services by jurisdiction, industry, or time namespace while preserving shared semantics for endpoint verification, policy enforcement, and settlement receipts.

### L7. Deployment Consistency Note

These profiles describe operational surfaces rather than separate inventions. A system remains within the disclosed architecture when gateway, market, vault, analytics, and index roles continue to rely on authenticated endpoint records, policy-bounded issuance semantics, and tamper-evident receipt trails.

### APPENDIX M: TECHNICAL EFFECTS AND IMPLEMENTATION CONSISTENCY NOTES

This appendix summarizes implementation-neutral technical effects and consistency notes aligned with identity anchoring, time-proof generation, policy-controlled issuance, namespace routing, atomic settlement, and audit workflows.

### M1. Technical Effects

Deterministic replay prevention across distributed nodes by binding event commitments to validity windows, freshness checks, and replay-prevention state transitions, thereby reducing duplicate issuance and stale re-use of proofs.
Tamper-evident provenance and auditable receipts by anchoring decision, mint, and settlement receipts to integrity-preserving structures and preserving reproducible reason paths.
Policy-controlled issuance with versioned enforcement by using authenticated policy bundles with effective windows, jurisdiction-routing rules, and clearly logged cap and threshold states.
Routable, verifiable service discovery by resolving namespace basepoints to authenticated endpoint records for minting, policy retrieval, audit export, listing control, and clearing functions.
Selective audit with privacy preservation by verifying compliance, receipt integrity, and settlement status without disclosing unnecessary personal or behavioral data.

### M2. Implementation Consistency Notes

Prefer implementation-neutral class terms such as tamper-evident data structure, identity-anchor token, validity window, authenticated endpoint record, and policy bundle so that equivalent secure implementations remain within the described architecture.
Keep atomic state transition semantics explicit where minting, receipt anchoring, and settlement commitment are coordinated, including committed, pending-confirmation, denied, frozen, and rolled-back states when applicable.
Keep routing tied to technically verifiable endpoint discovery, including signature checks, revocation checks, interface versioning, and audit-export reachability.
Describe measurable operational effects in terms of replay resistance, reduced reconciliation overhead, receipt verifiability, finality consistency, and privacy-preserving compliance verification.

### M3. Example Consistency Checks

Confirm that each decision or mint event records a policy version, rule identifier, reason code, and reproducible verification path.
Confirm that settlement transitions preserve finality state, rollback semantics where applicable, and rate or oracle provenance when conversion occurs.
Confirm that audit exports and namespace-resolution outputs are consistent with the endpoint records and interface contracts used elsewhere in the specification.

### APPENDIX N: PROTOCOL STACK AND STANDARDIZED INTERFACE FAMILIES (ILLUSTRATIVE, NON-LIMITING)

### N1. Protocol-Stack Overview.

In some embodiments, the disclosed system may be described as a protocol stack comprising coordinated identity, event, proof, policy, minting, routing, clearing, and index layers. This terminology is provided for implementation organization and interoperability explanation and does not limit the claimed embodiments to any particular software packaging or deployment topology.

### N2. Identity and Authorization Family.

The identity layer may expose one or more BEI-compatible identity-anchor interfaces configured to bind a subject, an organization, or a delegated service role to a resolvable namespace identifier, public-key credential, revocation status, and authorization state. Identity assertions may be represented using signed records, attestations, or verifiable tokens suitable for policy evaluation and endpoint routing.

### N3. Behavioral Event Family.

The event layer may expose standardized behavior-record interfaces for capturing an activity category, a time quantity, a context descriptor, one or more attestations, an evidence commitment, and anti-replay elements. Such interfaces may be used by care, education, production, community, medical, public-service, or other category-specific nodes without changing the canonical proof and mint semantics described herein.

### N4. Time-Proof Family.

The proof layer may expose canonicalization, commitment, signature, freshness-check, and verification interfaces configured to generate and validate Time-Proofs within validity windows and to reject duplicated, stale, inconsistent, or unauthorized event submissions.

### N5. Policy-Bundle Family.

The policy layer may expose signed and versioned policy-bundle interfaces defining authorized sources, eligible categories, weighting coefficients, rate limits, caps, privacy constraints, routing rules, and audit permissions. Policy bundles may be fetched, cached, verified, version-checked, and applied deterministically by minting, clearing, analytics, and audit nodes.

### N6. Time-Mint Family.

The minting layer may expose request, evaluation, decision, commit, and receipt-generation interfaces configured to transform a verified behavioral time event into a ledger-compatible time-denominated value unit through an atomic state transition. The minting layer may generate mint certificates, decision receipts, and commitment anchors while preserving replay-prevention and policy-consistency constraints.

### N7. Namespace-Routing and Endpoint-Record Family.

The routing layer may expose namespace-resolution and endpoint-record interfaces configured to resolve basepoints and sub-basepoints to authoritative minting, policy, audit, exchange, clearing, analytics, or beneficiary-transfer services. Endpoint records may include service URIs, interface versions, public-key references, revocation status, policy pointers, and audit-export pointers.

### N8. Exchange, Clearing, and Settlement Family.

The exchange and clearing layer may expose listing, matching, netting, settlement-instruction, settlement-receipt, reconciliation, and exception-handling interfaces. Such interfaces may support conversion among internal time-denominated units, behavior-referenced units, and external rails or reference units while recording rate snapshots, oracle provenance, and finality indicators.

### N9. Index and Analytics Family.

The index layer may expose metric-computation, signed report export, dashboard query, audit feed, and policy-feedback interfaces configured to derive contribution indices, trust metrics, volatility metrics, category balance indicators, and other machine-verifiable analytics from system activity.

### N10. Standardized Representations and Conformance.

In some embodiments, the foregoing interface families may be represented using normalized message schemas, signed receipts, endpoint records, and conformance checklists so that independently operated nodes can verify proofs, apply policies, exchange instructions, and reconcile outcomes without requiring a single centralized implementation.

### APPENDIX O: POLICY-GOVERNED VALUE TRANSFORMATION, EXCHANGE-RATE, AND INDEX LAYER (ILLUSTRATIVE, NON-LIMITING)

### O1. General.

The disclosed architecture may implement a policy-governed value-transformation layer configured to derive, adjust, convert, or report time-denominated or behavior-referenced value units from verified inputs while preserving the canonical underlying time-event semantics.

### O2. Inputs to Value Transformation.

Inputs to the value-transformation layer may include one or more of: verified time quantity, activity category, identity-anchor state, reputation metric, contribution index, context descriptor, policy version, jurisdictional constraints, rate limits, external conversion references, oracle provenance identifiers, and settlement conditions.

### O3. Transformation Semantics.

Value transformation may include category-dependent weighting, reputation-linked adjustment, context-sensitive prioritization, spread or cap application, exception handling, and conversion to settlement-ready representations. In some embodiments, such transformation changes the economic representation, routing treatment, or settlement conditions of a value unit without altering the canonical proof of the underlying behavioral time event.

### O4. Exchange-Rate and Reference-Value Records.

An exchange-rate or reference-value record may include a pair identifier, price or reference quantity, timestamp, provenance identifier, normalization basis, freshness state, and finality or applicability flag. Such records may be used by exchange gateways, clearing nodes, index nodes, or policy-feedback loops to produce settlement-ready decisions and auditable receipts.

### O5. Relationship to Dynamic Valuation.

Dynamic valuation may be applied as a policy-controlled layer over verified event-derived units and may incorporate reputation-linked, category-sensitive, or context-sensitive factors. Dynamic valuation may be computed for exchange, queueing, priority, risk management, settlement routing, or index publication while maintaining an audit trail that identifies the applied policy version and supporting inputs.

### O6. Relationship to Index Publication.

In some embodiments, aggregated outputs of the value-transformation layer may be published as one or more behavior-economy, contribution, trust, balance, or reference-value indices. Such indices may serve as machine-verifiable system signals for analytics, governance, market interfaces, or settlement reference operations.

### O7. External-Currency and External-Rail Interaction.

The value-transformation layer may cooperate with exchange and clearing interfaces to support controlled conversion or reference mapping involving external units, external rails, or external settlement systems, while preserving oracle provenance, policy constraints, replay resistance, and settlement finality semantics.

### APPENDIX P: SYSTEM-OF-SYSTEMS ARCHITECTURE, INFRASTRUCTURE, AND OPERATING CONTEXT (ILLUSTRATIVE, NON-LIMITING)

### P1. General System-of-Systems Context.

The disclosed embodiments may be implemented as a system of systems in which identity, event capture, proof generation, policy control, minting, routing, exchange, clearing, audit, beneficiary-transfer, and index services are independently deployable yet protocol-coordinated components.

### P2. Protocol Stack.

In a technical implementation context, the disclosed embodiments may be organized as a protocol stack in which lower layers provide identity anchoring, event representation, proof generation, and endpoint resolution, while upper layers provide policy enforcement, minting, exchange, clearing, analytics, and beneficiary-transfer operations.

### P3. Infrastructure Context.

In an infrastructure context, the disclosed embodiments may serve as a domain-anchored economic infrastructure in which namespace basepoints and signed endpoint records define routable entry points for identity services, minting services, exchange services, clearing services, analytics services, and governance services across multiple independently operated networks.

### P4. Operating-System Context.

In an operating-context description, the disclosed embodiments may be viewed as a coordinated operating environment for behavioral time-value issuance, routing, audit, settlement, and index publication, without implying limitation to any conventional computer operating system architecture. This operating-context description is intended to convey coordinated control of system resources, policies, and state transitions across multiple service layers.

### P5. Deployment Variants.

Deployment variants may include single-operator deployments, federated regional deployments, industry-specific deployments, organization-scoped deployments, multi-hive service partitions, and gateway-mediated interoperability deployments. A given deployment may expose different named service roles while preserving the canonical object definitions, proof semantics, receipt structures, policy-version controls, and settlement logic described herein.

### P6. Ecosystem Compatibility.

Subdomains, service-class identifiers, category tags, compatibility badges, SKU-style identifiers, or deployment-profile identifiers may be associated with value units, receipts, endpoint records, and registry entries for routing, policy selection, exchange listing, audit filtering, or interoperability purposes, without changing the canonical underlying time quantity or proof semantics.

### P7. Implementation Note.

The protocol-stack, infrastructure, and operating-context descriptions in this appendix are alternative descriptive views of the same disclosed system-of-systems architecture and are provided to clarify technical organization, deployment flexibility, and interoperability scope.

1. A computer-implemented system for generating and settling time-denominated value units from verified behavioral time events, comprising: a distributed ledger configured to store time-event records, mint certificates, decision receipts, and settlement receipts; a namespace resolver configured to resolve a human-readable namespace identifier to at least one endpoint and associated verification metadata; an identity module configured to authenticate a subject identity anchor and to associate the subject identity anchor with one or more non-transferable or substantially non-transferable identity-anchor tokens; an event-ingestion module configured to receive a digitally signed behavioral event record issued or attested by an authorized source, the behavioral event record comprising at least an activity category, a time range, and an evidence commitment; a time-proof engine configured to generate or verify a Time-Proof that binds the behavioral event record or the evidence commitment to a time reference and a validity window and includes replay-prevention material; a policy container configured to load and apply a signed, versioned policy bundle defining at least one of authorized sources, eligible activity categories, weighting coefficients, rate limits, caps, routing rules, privacy constraints, and audit permissions; a minting engine configured, upon successful verification of the subject identity anchor, the behavioral event record, the Time-Proof, and the policy bundle, to execute a single atomic state transition that (i) mints one or more time-denominated value units, (ii) binds the minted time-denominated value units to the subject identity anchor, and (iii) generates a mint certificate; and a clearing and settlement module configured to record a decision receipt and a settlement receipt for at least one transfer, conversion, exchange, or settlement transaction involving the time-denominated value units.

2. The system of claim 1, wherein the human-readable namespace identifier comprises a domain-based identifier and a subdomain-based identifier, and wherein the namespace resolver resolves the domain-based identifier and the subdomain-based identifier to a signed endpoint record identifying one or more minting, policy, audit, exchange, clearinghouse, or settlement endpoints.

3. The system of claim 1, wherein the authorized source is authorized under the signed, versioned policy bundle and the behavioral event record further comprises an issuer identifier and a digital signature verifiable against the authorized source.

4. The system of claim 3, wherein the authorized source comprises at least one of a service provider, employer, educator, medical provider, governmental node, community node, authenticated service terminal, threshold-signature group, or institutional attestor.

5. The system of claim 1, further comprising a key-rotation and revocation subsystem configured to maintain one or more revocation records for invalidated Time-Proofs, verifier credentials, endpoint records, or policy bundle versions, and to deny issuance when a required credential or proof is revoked.

6. The system of claim 1, further comprising a risk-scoring subsystem configured to compute a risk score based on at least one of duplicate-event detection, anomaly detection, issuance velocity, device-fingerprint consistency, or contextual inconsistency, wherein the risk score is recorded in the decision receipt and is usable to deny issuance, quarantine a pending mint, reduce an issuance cap, or require additional verification.

7. The system of claim 1, wherein the clearing and settlement module is configured to record, for a transaction involving the time-denominated value units, a finality state comprising at least one of committed, rolled-back, or pending-confirmation, and to store the finality state in both the settlement receipt and a reconciliation log.

8. A computer-implemented method for generating and settling time-denominated value units from verified behavioral time events, the method comprising: authenticating a subject identity anchor; receiving a digitally signed behavioral event record from an authorized source, the behavioral event record comprising an activity category, a time range, and an evidence commitment; generating or verifying a Time-Proof that binds the behavioral event record or the evidence commitment to a time reference and a validity window and includes replay-prevention material; loading a signed, versioned policy bundle defining at least one of authorized sources, eligible activity categories, weighting coefficients, rate limits, caps, routing rules, privacy constraints, and audit permissions; evaluating the behavioral event record and the Time-Proof against the signed, versioned policy bundle; upon approval, executing a single atomic state transition that mints one or more time-denominated value units, binds the minted time-denominated value units to the subject identity anchor, and generates a mint certificate; recording a decision receipt and, for a subsequent transfer, conversion, exchange, or settlement transaction, a settlement receipt; and routing at least one request associated with the time-denominated value units by resolving a namespace identifier to a signed endpoint record.

9. The method of claim 8, further comprising obtaining the behavioral event record from at least one of a mobile device, wearable device, Internet-of-Things device, authenticated service terminal, or enterprise service node.

10. The method of claim 8, further comprising selecting, based on at least one of a context descriptor, a service class, or a policy window, a category-specific endpoint associated with the signed endpoint record.

11. The method of claim 8, further comprising tokenizing at least one of the Time-Proof, the decision receipt, or the mint certificate as a non-fungible evidence token that references a corresponding ledger transaction and is access-controlled or transferable subject to the signed, versioned policy bundle.

12. The method of claim 8, further comprising converting the time-denominated value units into at least one of a digital fiat representation, stable-value token, central bank digital currency interface representation, or interoperable external settlement representation.

13. The method of claim 8, further comprising computing a time-value index metric based on at least one of issued units, redeemed units, verified contribution categories, or dispute outcomes, and exporting the time-value index metric as a signed, machine-readable, auditable report.

14. The method of claim 8, further comprising, upon detecting a triggering condition under the signed, versioned policy bundle and validating a beneficiary rule, transferring at least one of the time-denominated value units or a corresponding beneficiary allocation to a beneficiary identity anchor.

15. A non-transitory computer-readable medium storing instructions that, when executed by one or more processors, cause the one or more processors to: authenticate a subject identity anchor; receive a behavioral event record issued or attested by an authorized source; generate or verify a Time-Proof that binds the behavioral event record or an evidence commitment thereof to a time reference and a validity window and includes replay-prevention material; load and apply a signed, versioned policy bundle; execute a single atomic state transition that mints one or more time-denominated value units, binds the minted time-denominated value units to the subject identity anchor, and generates a mint certificate; record a decision receipt and a settlement receipt associated with at least one transfer, conversion, exchange, or settlement transaction involving the time-denominated value units; and resolve a namespace identifier to a signed endpoint record for at least one minting, policy, audit, exchange, clearinghouse, or settlement function.

16. The non-transitory computer-readable medium of claim 15, wherein the instructions further cause the one or more processors to generate a privacy-preserving presentation usable for selective audit or compliance verification to prove satisfaction of at least one issuance rule without revealing at least one sensitive attribute.

17. The non-transitory computer-readable medium of claim 15, wherein the signed endpoint record identifies a plurality of cross-domain endpoints including at least one policy endpoint, audit endpoint, clearing gateway endpoint, exchange gateway endpoint, or index gateway endpoint.

18. The non-transitory computer-readable medium of claim 15, wherein the settlement receipt records an exchange-rate input, a pair identifier, a timestamp or effective window, and an oracle provenance identifier associated with a conversion or settlement transaction.

19. The non-transitory computer-readable medium of claim 15, wherein the instructions further cause the one or more processors to perform, under enumerated conditions, a bounded reversal or bounded clawback recorded in a clawback receipt, without creating net new time-denominated value units beyond policy constraints.

20. The non-transitory computer-readable medium of claim 15, wherein the instructions further cause the one or more processors to compute, based on at least a first policy-defined value category and a second policy-defined value category, a volatility metric derived from issuance-flow difference, balance divergence, conversion slippage, or a combination thereof.
